(19) United States
(12) Patent Application Publication
(10) Pub. No.: US 2018/0367589 A1
(43) Pub. Date: Dec. 20, 2018

(54) Regrouping of video data by a network interface controller

(71) Applicant: Mellanox Technologies, Ltd., Yokneam (IL)

(72) Inventors: Dotan Levi, Kiryat Motzkin (IL); Michael Kagan, Zichron Yaakov (IL)

(21) Appl. No.: 15/622,094

(22) Filed: Jun. 14, 2017

(51) Int. Cl. H04L 29/06; H04N 21/61; H04N 21/23

(52) U.S. Cl. CPC H04L 65/60; H04N 21/6125; H04L 67/2823; H04L 65/4084; H04N 21/23

(57) ABSTRACT

Apparatus for data communications includes a host interface and a network interface, which receives from a packet communication network data packets containing video data comprising interleaved words of luminance data and chrominance data. In one embodiment, packet processing circuitry separates the luminance data from the chrominance data and writes the luminance data, via the host interface, to a luminance buffer in the host memory while writing the chrominance data, via the host interface, to at least one chrominance buffer in the memory, separate from the luminance buffer. In another embodiment, in which the video data include data words of more than eight bits, the packet processing circuitry writes the video data to at least one buffer while justifying the video data in the memory so that the video data with respect to successive pixels in the sequence are byte-aligned in the buffer.

### FIELD OF THE INVENTION

The present invention relates generally to network data communications, and particularly to methods and apparatus for handling streams of video data transmitted over a network.

### BACKGROUND

High-speed packet streaming schemes are commonly used in transmitting real-time video across a network. For professional applications, these schemes typically combine multiple pixels of raw (uncompressed) video data into large Internet Protocol (IP) packets. A number of standard protocols have been developed for this purpose. For example, the SMPTE 2022-6:2012 standard, entitled “Transport of High Bit Rate Media Signals over IP Networks (HBRMT)” specifies a format for transport of high bit-rate signals (including uncompressed video at bit rates of 3 Gbps) that are not encapsulated in MPEG-2 transport streams over IP networks using the Real-time Transport Protocol (RTP).

As another example, Request for Comments (RFC) 4175 of the Internet Engineering Task Force (IETF) defines an RTP payload format for uncompressed video. This payload format supports transport of pixel data in both RGB and various YCbCr (luminance/chrominance) formats. For instance, in YCbCr 4:2:2 format video, the Cb and Cr components are horizontally sub-sampled by a factor of two (so that each Cb and Cr sample corresponds to two Y components). Samples are assembled into packets in the order Cb0-Y0-Cr0-Y1, at 8, 10, 12 or 16 bits per sample.

The terms “luminance” and “chrominance” are used in the present description and in the claims to refer generically to component representations of video color space in which light intensity information, or luminance pixel component (often represented by Y or Y′), is separated from color information, or chrominance pixel components (represented, for example, as Cb/Cr, C_{B}/C_{R}, P_{B}/P_{R}, or U/V). Although there are some differences in computation of the different sorts of measures of luminance and chrominance and in the terminology used in referring to these measures, the principles of the present invention, as described below, are applicable to all such representations of video data.

### SUMMARY

Embodiments of the present invention that are described hereinbelow provide improved methods and apparatus for handling video data that are transmitted over a network.

There is therefore provided, in accordance with an embodiment of the invention, apparatus for data communications, including a host interface, which is configured to be connected to a bus of a host computer having a processor and a memory. A network interface is configured to receive from a packet communication network data packets containing video data including interleaved words of luminance data and chrominance data with respect to a sequence of pixels. Packet processing circuitry is coupled between the network interface and the host interface and is configured to separate the luminance data from the chrominance data and to write the luminance data, via the host interface, to a luminance buffer in the memory while writing the chrominance data, via the host interface, to at least one chrominance buffer in the memory, separate from the luminance buffer.

In one embodiment, the chrominance data include Cr component data and Cb component data, and the at least one chrominance buffer includes separate first and second buffers, and the packet processing circuitry is configured to separate the Cr component data from the Cb component data and to write the Cr component data to the first buffer while writing the Cb component data to the second buffer.

Additionally or alternatively, when the interleaved pixel components include more than eight bits per component, the packet processing circuitry can be configured to justify at least the luminance data in the memory so that the luminance data with respect to successive pixels in the sequence are byte-aligned in the luminance buffer.

There is also provided, in accordance with an embodiment of the invention, apparatus for data communications, including a host interface, which is configured to be connected to a bus of a host computer having a processor and a memory. A network interface is configured to receive from a packet communication network data packets containing video data including raw video data of more than eight bits per pixel component with respect to a sequence of pixels. Packet processing circuitry is coupled between the network interface and the host interface and is configured to write the video data, via the host interface, to at least one buffer in the memory while justifying the video data in the memory so that the video data with respect to successive pixels in the sequence are byte-aligned in the at least one buffer.

In some embodiments, the packet processing circuitry is configured to separate the data words into respective most significant bytes and remainders, and to justify the video data by writing the most significant bytes from the successive pixels to successive bytes in the buffer. In a disclosed embodiment, the packet processing circuitry is configured to separate the video data into subsequences including a predefined number of pixels in each subsequence, and to write the most significant bytes from the successive pixels in each subsequence to the predefined number of the successive bytes in the buffer, while grouping the remainders from the pixels in the subsequence into one or more further bytes in the buffer.

In an example embodiment, the data words include twelve bits per pixel component, and wherein the predefined number is four, and the packet processing circuitry is configured to separate each of the remainders into two most significant bits and two least significant bits, and to write the two most significant bits from all the remainders in each subsequence to a first one of the further bytes, while writing the two least significant bits from all the remainders in the subsequence to a second one of the further bytes.

Additionally or alternatively, the packet processing circuitry is configured to drop at least a predefined portion of the bits in the remainders without writing the predefined portion of the bits to the memory.

Further additionally or alternatively, when the video data include luminance data and chrominance data with respect to the sequence of pixels, the packet processing circuitry can be configured to write the luminance data and the chrominance data to separate, respective buffers in the memory while justifying the video data so that both the luminance data and the chrominance data are byte-aligned in the respective buffers.

There is additionally provided, in accordance with an embodiment of the invention, a method for data communications, which includes receiving in a network interface controller (NIC) of a host computer from a packet communication network data packets containing video data including interleaved pixel components of luminance data and chrominance data with respect to a sequence of pixels. The NIC separates the luminance data from the chrominance data, and writes the luminance data to a luminance buffer in a memory of the host computer while writing the chrominance data to at least one chrominance buffer in the memory, separate from the luminance buffer.

There is further provided, in accordance with an embodiment of the invention, a method for data communications, which includes receiving in a network interface controller (NIC) of a host computer from a packet communication network data packets containing video data including pixel components of more than eight bits per component with respect to a sequence of pixels. The NIC writes the video data to at least one buffer in a memory of the host computer while justifying the video data in the memory so that the video data with respect to successive pixels in the sequence are byte-aligned in the at least one buffer.

The present invention will be more fully understood from the following detailed description of the embodiments thereof, taken together with the drawings in which:

### BRIEF DESCRIPTION OF THE DRAWINGS

FIG. 1 is block diagram that schematically illustrates a system for video transmission over a network, in accordance with an embodiment of the invention;

FIG. 2 is a block diagram that schematically shows details of a host computer with a network interface controller (NIC) configured to receive video data from a network, in accordance with an embodiment of the invention;

FIG. 3 is a block diagram that schematically illustrates a stream of video data transmitted over a network; and

FIGS. 4A and 4B are block diagrams that schematically illustrate data buffers to which video data are written by a NIC, in accordance with an embodiment of the invention.

### DETAILED DESCRIPTION OF EMBODIMENTS

High-speed video streaming protocols, such as those mentioned above in the Background section, typically specify pixel data layouts in the packet payloads that conveniently support capture and streaming of digital images by camera hardware. Since such cameras commonly output interleaved digital luminance and chrominance values per pixel, the transmitted packets likewise contain luminance and chrominance data words in an interleaved format. The lengths of the data within a packet can vary among different standards and applications, but most commonly are 10 or 12 bits. It thus follows that data in the packet payloads are not byte-aligned, since the pixel components spread across byte boundaries. A given byte in the packet payload may contain, for example, two least significant bits of a 10-bit luminance component followed by the six most significant bits of the next chrominance component.

Although this format is widely used by camera manufacturers, it creates serious problems for host computers that are required to receive and process the data: Since luminance and chrominance are typically processed separately (for purposes of image enhancement, compression, and video encoding, for example), the receiving computer must first separate out the interleaved luminance and chrominance data and save them in separate buffers before processing the data. This need for rebuffering sets an upper limit on the rate at which a given computer (even a powerful computer) can accept a stream of video data and, in consequence, places a limit on the maximum output bandwidth of the cameras that collect and transmit the data.

Embodiments of the present invention that are described herein address these problems by offloading the steps of parsing and buffering incoming video data from the receiving host computer to the network interface controller (NIC) that connects the computer to the network. As the NIC receives video data packets from the network, it writes the data to buffers in the host memory by direct memory access (DMA), while hardware logic in the NIC rearranges the bits of video data on the fly using so as to place the data in the buffer in a format that is ready for processing by the host software. For example, the data may be rearranged in a format that enables host software to take advantage of the instruction set of the host processor, such as MMX™ instructions that enable Intel® Xeon® and other processors to operate on multiple successive bytes of data in the same clock cycle.

In some embodiments, the NIC separates the luminance data from the chrominance data in each packet and writes the luminance data to a luminance buffer in the host memory while writing the chrominance data to one or more chrominance buffers, separate from the luminance buffer. The chrominance data may all be written to the same buffer or, alternatively, the NIC may separate the Cr component data from the Cb component data and write each of these two chrominance components to its own buffer.

Additionally or alternatively, the NIC justifies the video data in the memory so that successive pixels in the sequence are byte-aligned in the buffer (or buffers, in the case of separate luminance and chrominance buffers), even when the data words are more than eight bits long. For this purpose, in some embodiments, the NIC separates the each word of video data (luminance, chrominance, or both) into a most significant byte and a remainder. It then justifies the video data by writing the most significant bytes from successive components within a group of pixels to successive bytes in the buffer, while saving the remainders elsewhere. For example, the NIC may separate the video data into subsequences, each comprising a group of a predefined number of pixels, and then write the most significant bytes from the pixel components of the successive pixels in each subsequence to a corresponding number of successive bytes in the buffer, while grouping the remainders from the pixels in the subsequence into one or more further bytes in the buffer. In some embodiments, the NIC does not write all of the bits of the remainders to the buffer, but may rather drop some of the remainder bits (particularly the chrominance bits) when they are not needed by the host, and thus reduce consumption of bus bandwidth and memory, as well as the processing burden on the CPU.

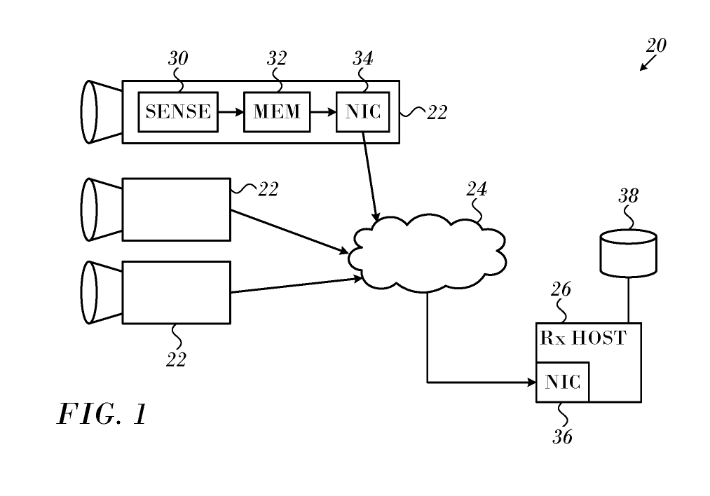

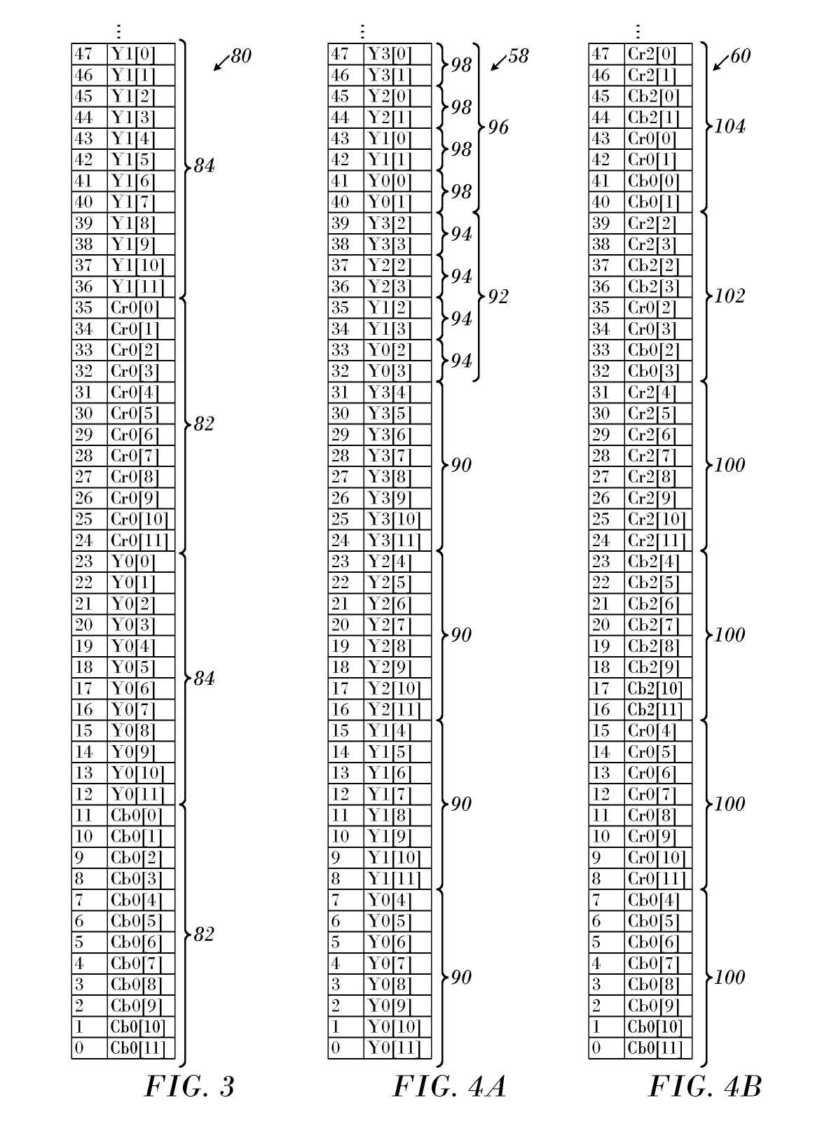

FIG. 1 is block diagram that schematically illustrates a system 20 for video transmission over a network 24, in accordance with an embodiment of the invention. One or more video sources, such as cameras 22, capture and transmit color video data over network 24 to a receiving host computer (Rx HOST) 26. For this purpose, each camera 22 typically comprises an image sensor 30, which captures and digitizes a sequence of video frames and writes luminance and chrominance data to a buffer 32 in pixel order. A transmitting NIC 34 packetizes and transmits the data at the acquisition rate in a standard packet format, such as RTP packets in accordance with one of the formats cited above in the Background section. An example format of this sort is shown below in FIG. 3. Alternatively or additionally, computer 26 may receive streams of input video data from other sources.

Host computer 26 is connected to network 24 by a receiving NIC 36, which receives the incoming video data packets from cameras 22. As described further hereinbelow, NIC 36 parses the packets and writes the data to a memory 38 of computer 26, while reordering the data in accordance with instructions received from the host computer. Examples of reordered data formats are shown below in FIGS. 4A/B.

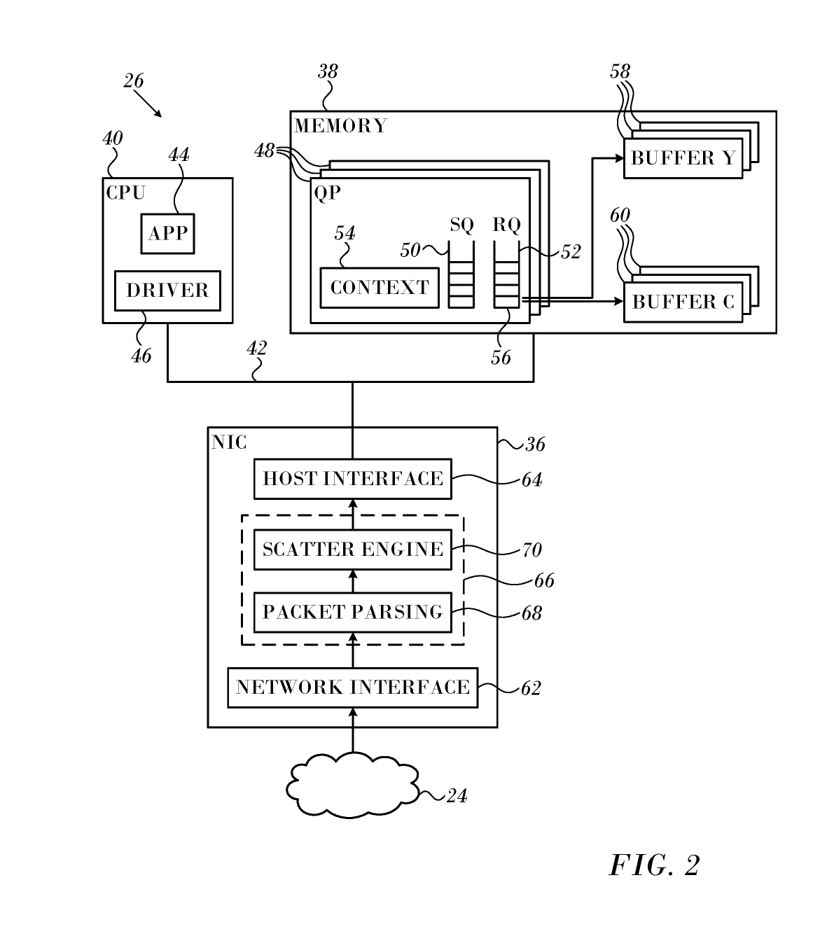

FIG. 2 is a block diagram that schematically shows details of host computer 26, including particularly the components of NIC 36 and the data structures in memory 38 that are used in receiving video data from network 24, in accordance with an embodiment of the invention. Computer comprises a central processing unit (CPU) 40, which communicates with NIC 36 via a bus 42, such as a Peripheral Component Interconnect (PCI) Express® bus.

CPU 40 in the present example runs a video application program 44, which processes video data that are received from network 24 and written by NIC 36 to memory 38. Application program 44 interacts with NIC 36 via a queue pair (QP) 48, which is assigned to the application program by a NIC driver program 46 running on CPU 40. (Typically, driver program 46 establishes multiple QPs to serve both application program 44 and other processes running on computer 26.) QP 48 comprises a send queue (SQ) 50 and a receive queue (RQ) 52, as are known in the art, with a QP context 54 containing metadata including, in the present case, information regarding the expected video packet format and data reordering format for this QP.

In order to receive video data from network 24, application program 44 allocates data buffers 58 and 60 in memory 38 and submits work requests to driver program 46 to receive data into these buffers. In the pictured example, buffers 58 and 60 include separate luminance (Y) buffers 58 and chrominance (C) buffers 60. In response to these work requests, driver program 46 posts work queue elements (WQEs) 56 in receive queue 52, pointing to respective buffers 58 and 60 to which NIC 36 is to write incoming video data.

Upon receiving a video packet or stream of packets over network 24 from one of cameras 22, NIC 36 reads one or more WQEs 56 from receive queue 52 of the appropriate QP 48 and then writes the pixel data, in the format and order indicated by QP context 54, to buffers 58 and 60 indicated by the WQE. NIC 36 performs these data writing and reordering functions by DMA over bus 42, without active involvement by CPU 40 in the actual data transfer. Once NIC 36 has finished writing a certain amount of video data (for example, a packet or group of packets, or possibly an entire frame) to buffers 58 and 60, it writes a completion report to a completion queue (not shown) in memory 38, in order to inform application program 44 that the data are ready for processing.

NIC 36 is connected to bus 42 by a host interface 64 and to network 24 by a network interface 62, which receives data packets containing video data comprising interleaved words of luminance data and chrominance data (as illustrated in FIG. 3). Packet processing circuitry 66, which is coupled between network interface 62 and host interface 64, both processes incoming packets received from network 24 and generates outgoing packets for transmission to the network. Typically, to maintain high throughput, packet processing circuitry 66 carries out these functions in dedicated hardware logic, although at least some of the processing and control operations of circuitry 66 may alternatively be implemented in software or firmware by an embedded programmable processor. The description that follows will focus on the specific functions of packet processing circuitry 66 that are involved in processing incoming video data packets. Other packet reception and transmission functions of NIC 36 will be familiar to those skilled in the art and are omitted from the present description for the sake of simplicity.

Packet processing circuitry 66 comprises packet parsing logic 68, which reads and analyzes the headers of incoming data packets. Upon receiving an incoming video packet from one of cameras 22, packet parsing logic 68 identifies the QP 48 to which the packet belongs and reads a receive WQE 56 from the appropriate receive queue 52 in order to identifying the buffers 58, 60 to which the packet data should be written. Based on the metadata in QP context 54, packet parsing logic 68 instructs a scatter engine 70 to write the luminance data in the packet payload to the designated luminance buffer 58 and to separately write the chrominance data in the packet payload to chrominance buffer 60.

As explained above, the instructions to scatter engine can involve one or both of de-interleaving the interleaved luminance and chrominance components in the packet payloads, and justifying the video data written to buffers 58 and 60 so that the data with respect to successive pixels are byte-aligned in the buffers. Scatter engine 70 writes the data in the proper order by DMA, thus relieving CPU 40 of any involvement in the tasks of data de-interleaving and justification.

Packet processing circuitry 66 writes the payload data to buffers 58 and 60 in the proper sequential order of the pixels in the transmitted video frames. In some cases, network 24 may be configured to guarantee in-order delivery of the packets to receiving host computer 26, so that no further effort is required by NIC 36 in this regard. Alternatively, some network transport protocols, such as RTP, include packet serial numbers in the packet headers, which can be used by packet processing circuitry 66 in checking and, in some cases, correcting for packets received out of order. Techniques that can be used for this purpose are described, for example, in U.S. patent application Ser. No. 15/473,668, filed Mar. 30, 2017, whose disclosure is incorporated herein by reference.

FIG. 3 is a block diagram that schematically illustrates a typical stream 80 of video data transmitted over network 24 by one of cameras 22. The figure shows only the first six bytes of data in stream 80, which are encapsulated and transmitted in a data packet, possibly as the initial part of a payload that includes a larger volume of pixel data. (These bytes make up a pixel group representing the smallest number of pixels that can be grouped together in byte-aligned memory, and are typically transmitted in the packet payload together with additional pixel groups.) Stream 80 comprises interleaved data words 82, 84 of chrominance data (Cb, Cr) and luminance data (Y), belonging to successive pixel components in a given frame. Each word 82, 84 in this example comprises twelve bits, ordered from the most significant bit (#11) to the least significant (#0). This particular format, along with the corresponding reordered buffer formats that are illustrated in the figures that follow, is shown only by way of example, however, and the principles of the present invention may similarly be applied, mutatis mutandis, to other color video formats that are known in the art.

FIGS. 4A and 4B are block diagrams that schematically illustrate the contents of data buffers 58, 60, respectively, to which video data have been written by NIC 36 in accordance with an embodiment of the invention. As shown in these figures, packet processing circuitry 66 separates data words 82, 84 of the incoming data packets into luminance and chrominance components and writes these components respectively to buffer 58 (FIG. 4A) and buffer (FIG. 4B). Packet processing circuitry 66 further separates each luminance word 84 into a respective most significant byte 90, comprising bit #11 through bit #4 in the present example, and a remainder, comprising bit #3 through bit #0. Circuitry 66 similarly separates out most significant bytes 100 of the successive Cb and Cr chrominance words from the corresponding remainders.

Packet processing circuitry 66 justifies the video data by writing most significant bytes 90 and 100 from successive pixels to successive bytes in the corresponding buffers 58 and 60, as illustrated by the first four bytes in each of FIGS. 4A and 4B. To enable efficient processing by CPU 40, it can be useful, as explained above, to write the most significant bytes of a certain number of consecutive pixels to consecutive respective locations in buffers 58 and 60, while the remainders are written to other locations (or possibly even discarded). For this purpose, packet processing circuitry 66 separates the video data into subsequences, each comprising a predefined number of pixels, for example, four consecutive pixels per subsequence, and writes most significant bytes 90, 100 from the successive pixels in each subsequence to the corresponding number of successive bytes in buffer 58 or 60.

In the present example, packet processing circuitry 66 groups the remainders from the pixels in the four-pixel subsequence into remainder bytes 92 and 96 in luminance buffer 58 and remainder bytes 102 and 104 in chrominance buffer 60. In this particular example, in which data words 82 and 84 each comprise twelve bits and the pixels are grouped in subsequences of four pixels, it can be useful to separate each of the remainders into two most significant bits 94 and two least significant bits 98. (For the sake of simplicity, these bits 94 and 98 are labeled only in FIG. 4A.) The two most significant bits 94 from all four remainders in the subsequence are written to byte 92, while the two least significant bits 98 from all four remainders in the subsequence are written to byte 96. This ordering scheme allows application 44 to truncate twelve-bit input data to ten or eight bits simply by skipping over bytes 92 and 96. Input data words of other lengths, for example ten or sixteen bits, can be buffered in similar fashion, with smaller or larger numbers of remainder bytes.

Alternatively, if QP context 54 indicates that the remainders of the incoming data words are not needed, packet processing circuitry 66 can itself drop all or a part of the remainders and write only the most significant bytes of the video data words, in sequential order, to buffers 58 and 60, possibly with some of the remainder bits. For example, if only ten bits of color depth are required, rather than twelve, packet processing circuitry 66 can write remainder bytes 102 but not remainder bytes 104 to buffer 60.

Although NIC 36 in the embodiments described above both separates incoming video data into luminance and chrominance components and justifies these components in buffers 58 and 60, NIC 36 may alternatively perform only one of these functions (component separation or justification), or may apply such functions only to a certain part of the video data. Furthermore, although the example embodiments described above all relate to handling of luminance and chrominance video components, the principles of the present invention (and specifically the techniques of data justification described above) may alternatively be applied, mutatis mutandis, to other video component schemes, such as RGB schemes. In the RGB example, each color component of the R, G and B may be written to a separate buffer and/or justified in the memory so that data associated with a certain color component of successive pixels in the video data sequence are byte-aligned in a corresponding buffer. All such alternative applications of the apparatus and methods described above are considered to be within the scope of the present invention.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for data communications, comprising:
a host interface, which is configured to be connected to a bus of a host computer having a processor and a memory;
a network interface, which is configured to receive from a packet communication network data packets containing video data comprising interleaved words of luminance data and chrominance data with respect to a sequence of pixels; and
packet processing circuitry, which is coupled between the network interface and the host interface and is configured to separate the luminance data from the chrominance data and to write the luminance data, via the host interface, to a luminance buffer in the memory while writing the chrominance data, via the host interface, to at least one chrominance buffer in the memory, separate from the luminance buffer.

2. The apparatus according to claim 1, wherein the chrominance data comprise Cr component data and Cb component data, and the at least one chrominance buffer comprises separate first and second buffers, and
wherein the packet processing circuitry is configured to separate the Cr component data from the Cb component data and to write the Cr component data to the first buffer while writing the Cb component data to the second buffer.

3. The apparatus according to claim 1, wherein the interleaved words comprise more than eight bits per pixel component, and wherein the packet processing circuitry is configured to justify at least the luminance data in the memory so that the luminance data with respect to successive pixels in the sequence are byte-aligned in the luminance buffer.

4. Apparatus for data communications, comprising:
a host interface, which is configured to be connected to a bus of a host computer having a processor and a memory;
a network interface, which is configured to receive from a packet communication network data packets containing video data comprising data words of more than eight bits per pixel component with respect to a sequence of pixels; and
packet processing circuitry, which is coupled between the network interface and the host interface and is configured to write the video data, via the host interface, to at least one buffer in the memory while justifying the video data in the memory so that the video data with respect to successive pixels in the sequence are byte-aligned in the at least one buffer.

5. The apparatus according to claim 4, wherein the packet processing circuitry is configured to separate the data words into respective most significant bytes and remainders, and to justify the video data by writing the most significant bytes from the successive pixels to successive bytes in the buffer.

6. The apparatus according to claim 5, wherein the packet processing circuitry is configured to separate the video data into subsequences comprising a predefined number of pixels in each subsequence, and to write the most significant bytes from the successive pixels in each subsequence to the predefined number of the successive bytes in the buffer, while grouping the remainders from the pixels in the subsequence into one or more further bytes in the buffer.

7. The apparatus according to claim 6, wherein the data words comprise twelve bits per pixel component, and wherein the predefined number is four, and
wherein the packet processing circuitry is configured to separate each of the remainders into two most significant bits and two least significant bits, and to write the two most significant bits from all the remainders in each subsequence to a first one of the further bytes, while writing the two least significant bits from all the remainders in the subsequence to a second one of the further bytes.

8. The apparatus according to claim 5, wherein the packet processing circuitry is configured to drop at least a predefined portion of the bits in the remainders without writing the predefined portion of the bits to the memory.

9. The apparatus according to claim 4, wherein the video data comprise luminance data and chrominance data with respect to the sequence of pixels, and wherein the packet processing circuitry is configured to write the luminance data and the chrominance data to separate, respective buffers in the memory while justifying the video data so that both the luminance data and the chrominance data are byte-aligned in the respective buffers.

10. A method for data communications, comprising:
receiving in a network interface controller (NIC) of a host computer from a packet communication network data packets containing video data comprising interleaved words of luminance data and chrominance data with respect to a sequence of pixels; and
in the NIC, separating the luminance data from the chrominance data and writing the luminance data to a luminance buffer in a memory of the host computer while writing the chrominance data to at least one chrominance buffer in the memory, separate from the luminance buffer.

11. The method according to claim 10, wherein the chrominance data comprise Cr component data and Cb component data, and the at least one chrominance buffer comprises separate first and second buffers, and
wherein writing the chrominance data comprises separating the Cr component data from the Cb component data and writing the Cr component data to the first buffer while writing the Cb component data to the second buffer.

12. The method according to claim 10, wherein the interleaved words comprise more than eight bits per pixel component, and wherein writing the luminance data comprises justifying, by the NIC, at least the luminance data in the memory so that the luminance data with respect to successive pixels in the sequence are byte-aligned in the luminance buffer.

13. A method for data communications, comprising:
receiving in a network interface controller (NIC) of a host computer from a packet communication network data packets containing video data comprising data words of more than eight bits per pixel component with respect to a sequence of pixels; and
writing the video data from the NIC to at least one buffer in a memory of the host computer while justifying the video data in the memory so that the video data with respect to successive pixels in the sequence are byte-aligned in the at least one buffer.

14. The method according to claim 13, wherein justifying the video data comprises separating the data words into respective most significant bytes and remainders, and writing the most significant bytes from the successive pixels to successive bytes in the buffer.

15. The method according to claim 14, wherein writing the video data comprises separating the video data into subsequences comprising a predefined number of pixels in each subsequence, and writing the most significant bytes from the successive pixels in each subsequence to the predefined number of the successive bytes in the buffer, while grouping the remainders from the pixels in the subsequence into one or more further bytes in the buffer.

16. The method according to claim 15, wherein the data words comprise twelve bits per pixel component, and wherein the predefined number is four, and
wherein separating the video data comprises separating each of the remainders into two most significant bits and two least significant bits, and writing the two most significant bits from all the remainders in each subsequence to a first one of the further bytes, while writing the two least significant bits from all the remainders in the subsequence to a second one of the further bytes.

17. The method according to claim 14, wherein separating the data words comprises dropping, by the NIC, at least a predefined portion of the bits in the remainders without writing the predefined portion of the bits to the memory.

18. The method according to claim 13, wherein the video data comprise luminance data and chrominance data with respect to the sequence of pixels, and wherein writing the video data comprises writing the luminance data and the chrominance data to separate, respective buffers in the memory while justifying the video data so that both the luminance data and the chrominance data are byte-aligned in the respective buffers.
